(19) United States
(12) Patent Application Publication
(10) Pub. No.: US 2009/0320063 A1
(43) Pub. Date: Dec. 24, 2009

(54) LOCAL ADVERTISEMENT INSERTION DETECTION

(75) Inventor: Peter T. Barrett, San Francisco, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/143,830

(22) Filed: Jun. 23, 2008

(51) Int. Cl. H04N 7/025

(52) U.S. Cl. 725/34; 725/32; 725/36

(57) ABSTRACT

Local advertisement insertion detection is described. In embodiment(s), a video feed of television media content can be received for distribution to media devices, and the video feed can include national advertisements and spliced-in local advertisements. A splice point in the video feed can be detected that indicates where a local advertisement has been inserted into the video feed.

### BACKGROUND

Typically, national video feeds are received for various television channels, and local or regional advertisements can then be inserted into the television channels that are broadcast to subscribers of a television service. Additionally, national advertisements that are included in the national video feeds can be replaced with local or region specific advertisements for local advertising to viewers of a particular region. The local advertisements for products and services are typically a primary source of revenue for a content distributor that receives and distributes the national video feeds of television channels, and advertisers want to know which of their advertisements are being sold and included in the television channels that are broadcast for viewing.

### SUMMARY

This summary is provided to introduce simplified concepts of local advertisement insertion detection. The simplified concepts are further described below in the Detailed Description. This summary is not intended to identify essential features of the claimed subject matter, nor is it intended for use in determining the scope of the claimed subject matter.

Local advertisement insertion detection is described. In embodiment(s), a video feed of television media content can be received for distribution to media devices, and the video feed can include national advertisements and spliced-in local advertisements. A splice point in the video feed can be detected that indicates where a local advertisement has been inserted into the video feed.

In other embodiment(s), the splice point in the video feed that indicates where a local advertisement has been inserted can be detected as a video frame pattern change from the video feed to video of the local advertisement; as a timing clock change from the video feed to video of the local advertisement; as a change in picture group signaling from the video feed to video of the local advertisement; as a signature of insertion equipment that inserts the local advertisement into the video feed; as a bit rate change from the video feed to video of the local advertisement; as Extended Data Services (XDS) ancillary data discontinuity from the video feed to video of the local advertisement; and/or as a change in an audio bit rate from the video feed to video of the local advertisement.

### BRIEF DESCRIPTION OF THE DRAWINGS

Embodiments of local advertisement insertion detection are described with reference to the following drawings. The same numbers are used throughout the drawings to reference like features and components:

FIG. 1 illustrates an example system in which embodiments of local advertisement insertion detection can be implemented.

FIG. 2 illustrates example method(s) for local advertisement insertion detection in accordance with one or more embodiments.

FIG. 3 illustrates various components of an example device which can implement embodiments of local advertisement insertion detection.

### DETAILED DESCRIPTION

Embodiments of local advertisement insertion detection provide that an advertisement can be detected at a splice point where the advertisement is inserted into a video feed. A content distributor that receives a video feed which includes national advertisements and inserted or spliced-in local advertisements can detect the inserted advertisements and develop advertisement analysis information. For example, advertisers currently rely on viewers to report the advertisements that they have viewed while watching television. The advertisers would prefer a more precise system that can automatically report the advertisements that have been distributed for viewing so that an advertiser can audit the advertisements that have been paid for distribution. An advertiser will also be able to determine the mix of national and local advertisement inventory that is distributed for viewing to know which advertisements are selling. A local affiliate that does not sell an advertisement spot may instead run a free advertisement or a self-promoting advertisement. An advertiser may then be able to negotiate a better advertising rate knowing that a distributor is unable to sell all of the available advertising spots.

While features and concepts of the described systems and methods for local advertisement insertion detection can be implemented in any number of different environments, systems, and/or various configurations, embodiments of local advertisement insertion detection are described in the context of the following example systems and environments.

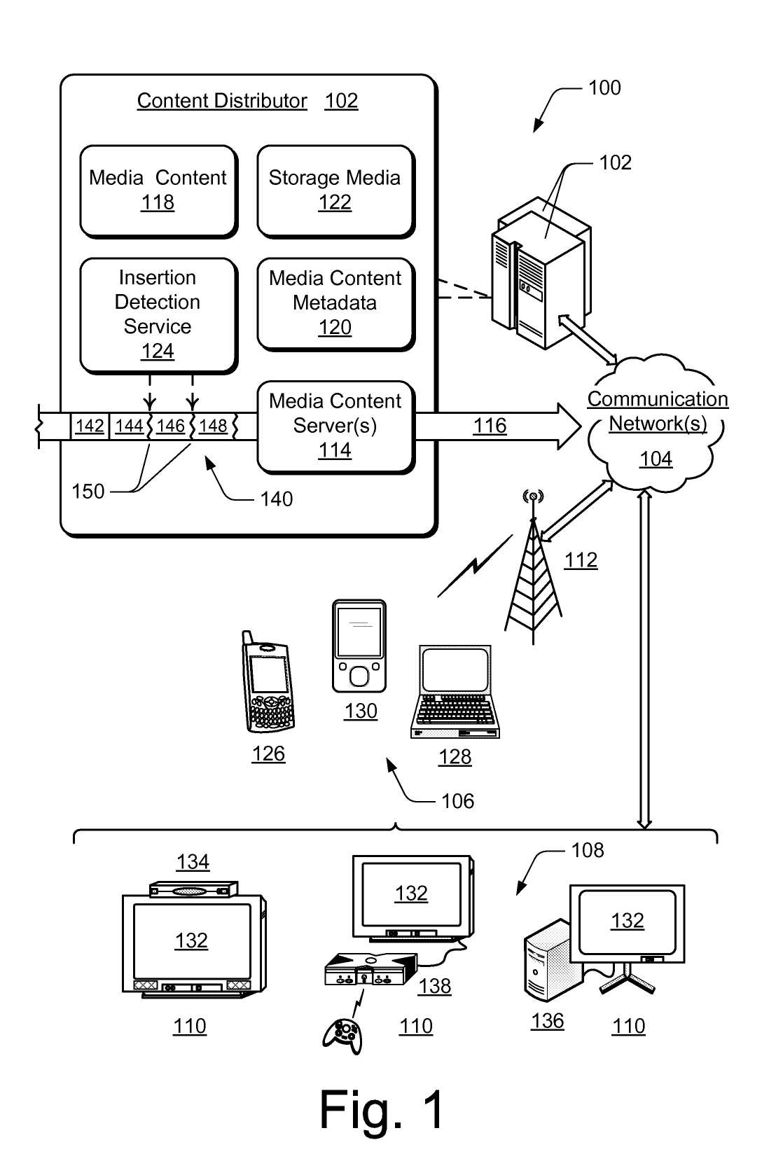

FIG. 1 illustrates an example system 100 in which various embodiments of local advertisement insertion detection can be implemented. In this example, system 100 includes one or more content distributors 102 that communicate or otherwise provide media content to any number of various media devices via communication network(s) 104. The various media devices can include wireless media devices 106 as well as other media devices 108 (e.g., wired and/or wireless client devices) that are implemented as components in various client systems 110. In a media content distribution system, the content distributors 102 facilitate the distribution of media content, content metadata, and/or other associated data to multiple viewers, users, viewing systems, and devices.

The communication network(s) 104 can be implemented to include any type of data network, voice network, broadcast network, an IP-based network, a wide area network (e.g., the Internet), and/or a wireless network 112 that facilitates media content distribution and data communication between the content distributors 102 and any number of the various media devices. The communication network(s) 104 can also be implemented using any type of network topology and/or communication protocol, and can be represented or otherwise implemented as a combination of two or more networks. Any one or more of the arrowed communication links facilitate two-way data communication, such as from the content distributor 102 to a media device 108 (e.g., a client device) and vice-versa.

The content distributor 102 can include media content servers 114 that are implemented to receive video feeds 116 of television media content for distribution to media devices. The content distributor 102 can receive the video feeds 116 of television media content from various content sources, such as national television providers that distribute a national video feed of television media content to a local affiliate that picks up the video feed for broadcast or other distribution, such as to content distributor 102 that then distributes the television media content to the subscriber media devices. The content distributor 102 can communicate or otherwise distribute media content 118 (e.g., to include the television media content) and/or other data to any number of the various wireless media devices 106 and other media devices 108.

The media content 118 (e.g., to include recorded media content) can include any type of audio, video, and/or image media content received from any type of media content source. As described throughout, “media content” can include television programs (or programming), advertisements, commercials, music, movies, and on-demand media content. Other media content can include interactive games, network-based applications, and any other audio, video, and/or image content (e.g., to include program guide application data, user interface data, advertising content, closed captions data, content metadata, search results and/or recommendations, and the like).

Other media content can include media content metadata 120 that includes identifying criteria, descriptive information, and/or attributes associated with the media content 118 that can describe and categorize the media content. The metadata 120 associated with a television program, movie, or advertisement can be any form of information that describes and/or characterizes the media content. For example, metadata can include a program or movie identifier, a title, a subject description of the program, movie, or advertisement, a plot description, actor information, a date of production, broadcast channel, television network, artistic information, music compilations, and any other possible descriptive information about the media content. Further, metadata can characterize a genre that describes the media content as being an advertisement, a movie, a comedy show, a sporting event, a news program, a sitcom, a talk show, an action/adventure program, or as any number of other category descriptions.

In the example system 100, the content distributor 102 includes storage media 122 to store or otherwise maintain various data and media content, such as media content 118 and media content metadata 120. In a Network Digital Video Recording (nDVR) implementation, recorded on-demand assets can be recorded when initially distributed to the various media devices as scheduled television media content (e.g., from the video feed 116 of television media content), and stored with the storage media 122 or other suitable storage device. The storage media 122 can be implemented as any type of memory, random access memory (RAM), read only memory (ROM), any type of magnetic or optical disk storage, and/or other suitable electronic data storage.

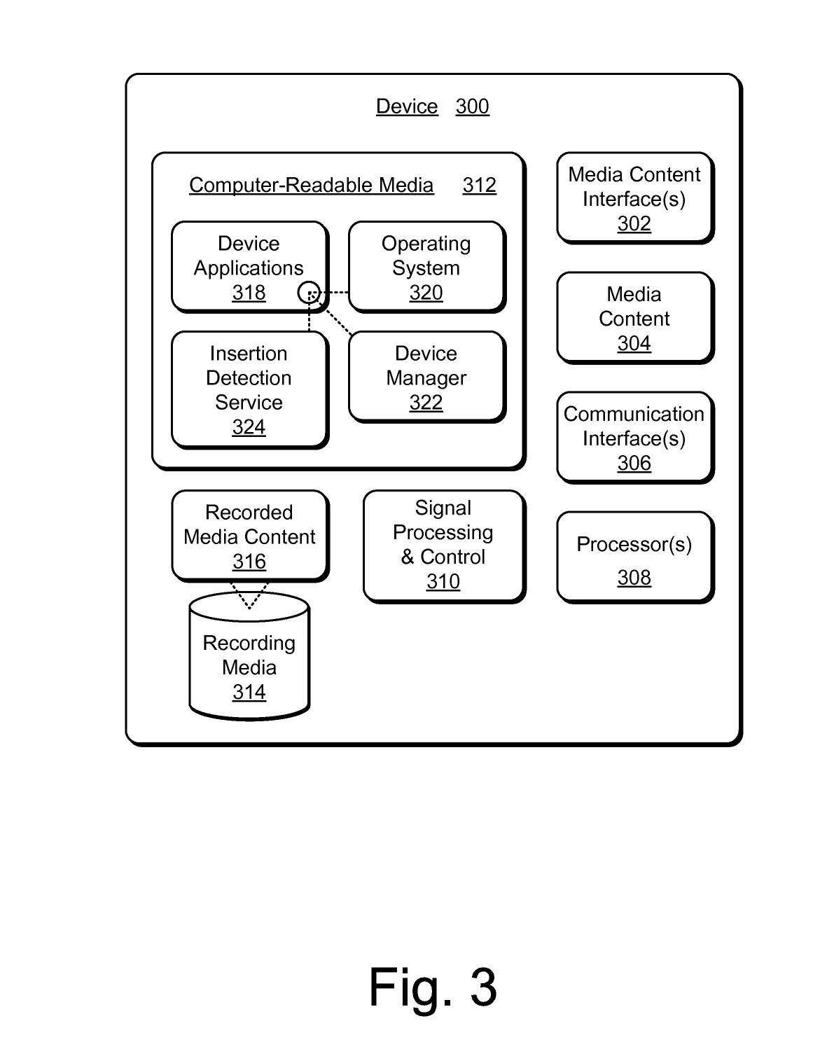

Content distributor 102 also includes an insertion detection service 124 that can be implemented as computer-executable instructions and executed by processor(s) to implement various embodiments and/or features of local advertisement insertion detection. In addition, a content distributor 102 can be implemented with any number and combination of differing components as further described with reference to the example device shown in FIG. 3. Although illustrated and described as a component or module of the content distributor 102, the insertion detection service 124, as well as other functionality described to implement embodiments of local advertisement insertion detection, can also be provided as a service apart from the content distributor 102 (e.g., on a separate server or by a third party service).

The wireless media devices 106 can include any type of device implemented to receive and/or communicate wireless data, such as any one or combination of a mobile phone device 126 (e.g., cellular, VoIP, WiFi, etc.), a portable computer device 128, a media device 130 (e.g., a personal media player, portable media player, etc.), and/or any other wireless media device that can receive media content in any form of audio, video, and/or image data. Each of the client systems 110 include a respective client device and display device 132 that together render or playback any form of audio, video, and/or image content, media content, and/or television content.

A display device 132 can be implemented as any type of a television, high definition television (HDTV), LCD, or similar display system. A client device in a client system 110 can be implemented as any one or combination of a television client device 134 (e.g., a television set-top box, a digital video recorder (DVR), etc.), a computer device 136, a gaming system 138, an appliance device, an electronic device, and/or as any other type of client device that can be implemented to receive television content or media content in any form of audio, video, and/or image data in a media content distribution system.

Any of the wireless media devices 106 and/or other media devices 108 can be implemented with one or more processors, communication components, memory components, signal processing and control circuits, and a media content rendering system. A media device may also be associated with a user or viewer (i.e., a person) and/or an entity that operates the device such that a media or client device describes logical devices that include users, software, and/or a combination of devices.

The media content servers 114 at content distributor 102 can receive the video feed 116 of television media content 118 that includes national advertisements and spliced-in local advertisements. A video feed 116, or video stream, can include multiple segments of television programming (for one or more television programs) interspersed or separated by multiple advertisement pods, each having one or more advertisements or commercials for various products and/or services. In this example, the video feed 116 includes an advertisement pod 140 that includes national advertisements 142 and 144, as well as spliced-in local advertisements 146 and 148. The local advertisements 146 and 148 are spliced into the video feed 116 at splice points generally identified at 150.

In one or more embodiments, the insertion detection service 124 at content distributor 102 can be implemented to detect a splice point 150 in the video feed 116 that indicates where a local advertisement 146 or 148 has been inserted into the video feed. In various embodiments, the insertion detection service 124 can detect a splice point in an MPEG transport stream by various techniques that include, but are not limited to, detecting a video frame pattern change from the video feed to video of the local advertisement; a timing clock change from the video feed to video of the local advertisement; a change in picture group signaling from the video feed to video of the local advertisement; a signature of insertion equipment that inserts the local advertisement into the video feed; a bit rate change from the video feed to video of the local advertisement; Extended Data Services (XDS) ancillary data discontinuity from the video feed to video of the local advertisement; and/or a change in an audio bit rate from the video feed to video of the local advertisement.

In an embodiment, the insertion detection service 124 at the content distributor 102 can detect a splice point 150 in a video feed 116 of television media content as a forced quantization match of video of a local advertisement 146 that has been inserted into the video feed. A forced quantization match can occur at a splice point 150 when advertisement insertion equipment forces a quantization match of the video of an inserted advertisement to the buffered video of the video feed (e.g., matches the buffer model of the video feed). At or near the beginning of an inserted advertisement, scene changes from the video feed to the inserted advertisement can correlate to a change in the video rate which is forced to match the video rate of the video feed. Typically, the quantization can initially be at its highest (e.g., having a higher Q-factor) at the insertion or splice point 150 of the inserted advertisement into the video feed 116.

In another embodiment, the insertion detection service 124 at the content distributor 102 can detect a splice point 150 in the video feed 116 as a video frame pattern change from the video feed to video of the local advertisement that has been inserted into the video feed. In an MPEG video stream, for example, a change in the I-frame, P-frame, and/or B-frame cadence can indicate a splice point 150. For example, the video feed 116 may have a combination of ordered I-frames and P-frames intermixed with B-frames, whereas an inserted advertisement may only have a combination of I-frames and P-frames. A change from a frame pattern of the video feed 116 to a frame pattern of the video of an inserted advertisement can indicate advertisement insertion boundaries (e.g., a splice point 150). In addition, a frame pattern change from the video feed to the video of the inserted advertisement followed approximately thirty seconds later by another frame pattern change from the video of the inserted advertisement back to the video feed is an additional indication of an inserted advertisement.

In another embodiment, the insertion detection service 124 at the content distributor 102 can detect a splice point 150 in the video feed 116 as a timing clock change from the video feed to video of the local advertisement that has been inserted into the video feed. Typically, various timing clocks in an MPEG transport stream are sequentially increasing. When a timing clock of the video suddenly changes (e.g., to a previous time, or jumps ahead in time more than would be expected), the timing clock change can be detected as a splice point 150 that indicates where an advertisement has been inserted into the video feed 116.

In another embodiment, the insertion detection service 124 at the content distributor 102 can detect a splice point 150 in the video feed 116 as a change in picture group signaling from the video feed to video of the local advertisement that has been inserted into the video feed. A change to the MPEG encoded redundancy that includes groups of pictures (GOPs) composed of I-frames, B-frames, and/or P-frames can be detected as a splice point 150 that indicates where an advertisement has been inserted into the video feed 116.

In another embodiment, the insertion detection service 124 at the content distributor 102 can detect a splice point 150 in the video feed 116 as a signature of advertisement insertion equipment that inserts the local advertisement into the video feed. A signature of the advertisement insertion equipment can be detected as a vertical and/or horizontal resolution change from the video feed to the video of the inserted advertisement. The resolution change can be detected as a splice point 150 that indicates where an advertisement has been inserted into the video feed 116.

In another embodiment, the insertion detection service 124 at the content distributor 102 can detect a splice point 150 in the video feed 116 as a bit rate change from the video feed to video of the local advertisement that has been inserted into the video feed. For a channel in the video feed 116, a bit rate can go “flat” where a local advertisement is inserted into the video feed, and the flat bit rate can be detected as a splice point 150.

In another embodiment, the insertion detection service 124 at the content distributor 102 can detect a splice point 150 in the video feed 116 as Extended Data Services (XDS) ancillary data discontinuity from the video feed to video of the local advertisement that has been inserted into the video feed. The XDS is a standard by which ancillary data (e.g., metadata, clock data, etc.) can be delivered along with or as part of the video feed 116. A sudden change in the ancillary data, such as a clock change, can be detected as a splice point 150 that indicates where an advertisement has been inserted into the video feed.

In another embodiment, the insertion detection service 124 at the content distributor 102 can detect a splice point 150 in the video feed 116 as a change in an audio bit rate from the video feed to video of the local advertisement that has been inserted into the video feed. A shift in the audio Kbit rate from the video feed 116 to the video for an inserted advertisement can be detected as a splice point 150 that indicates where an advertisement has been inserted into the video feed 116.

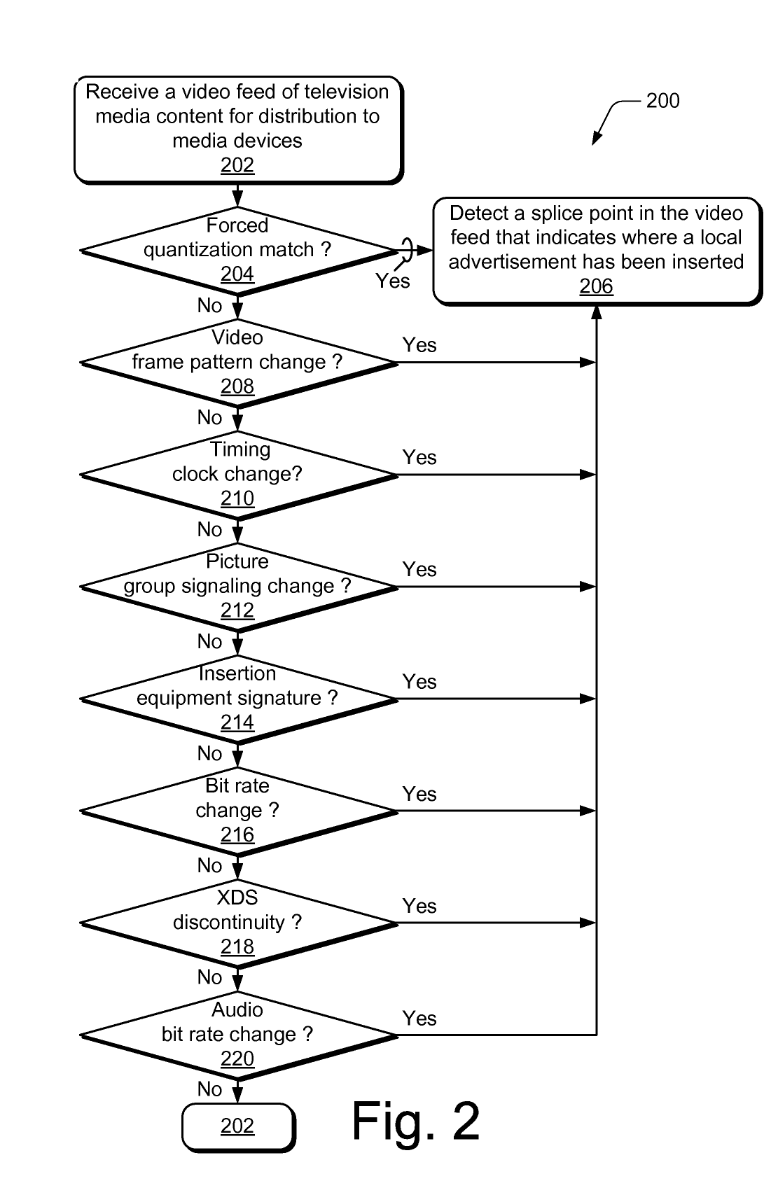

Example method 200 is described with reference to FIG. 2 in accordance with one or more embodiments of local advertisement insertion detection. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. Example method 200 may be described in the general context of computer-executable instructions which can include software, applications, routines, programs, objects, functions, methods, procedures, components, modules, and the like.

The method(s) may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 2 illustrates example method(s) 200 of local advertisement insertion detection. The order in which the method is described is not intended to be construed as a limitation, and any number of the described method blocks can be combined in any order to implement the method, or an alternate method.

At block 202, a video feed of television media content is received for distribution to media devices. For example, a media content server 114 at content distributor 102 (FIG. 1) receives the video feed 116 of television media content that includes national advertisements 142 and 144, and includes spliced-in local advertisements 146 and 148.

At block 204, a determination is made as to whether a forced quantization match is detected of video of the local advertisement that has been inserted into the video feed. If a forced quantization match is detected (i.e., “yes” from block 204), then at block 206, a splice point is detected in the video feed that indicates where a local advertisement has been inserted into the video feed. For example, the insertion detection service 124 at content distributor 102 detects a forced quantization match as a splice point 150 where advertisement insertion equipment has forced a quantization match of the video to insert an advertisement into the buffered video of the video feed (e.g., matches the buffer model of the video feed).

If a forced quantization match is not detected (i.e., “no” from block 204), then at block 208, a determination is made as to whether a video frame pattern change is detected from the video feed to video of the local advertisement that has been inserted into the video feed. If a video frame pattern change is detected (i.e., “yes” from block 208), then at block 206, a splice point is detected in the video feed that indicates where a local advertisement has been inserted into the video feed. For example, the insertion detection service 124 at content distributor 102 detects a change to the frame pattern or cadence of an MPEG video feed as a splice point 150 where a local advertisement has been inserted into the video feed.

If a video frame pattern is not detected (i.e., “no” from block 208), then at block 210, a determination is made as to whether a timing clock change is detected from the video feed to video of the local advertisement that has been inserted into the video feed. If a timing clock change is detected (i.e., “yes” from block 210), then at block 206, a splice point is detected in the video feed that indicates where a local advertisement has been inserted into the video feed. For example, the insertion detection service 124 at content distributor 102 detects a sudden change to a timing clock of the video feed 116 as a splice point 150 that indicates where an advertisement has been inserted into the video feed 116.

If a timing clock change is not detected (i.e., “no” from block 210), then at block 212, a determination is made as to whether a change in picture group signaling is detected from the video feed to video of the local advertisement that has been inserted into the video feed. If a change in the picture group signaling is detected (i.e., “yes” from block 212), then at block 206, a splice point is detected in the video feed that indicates where a local advertisement has been inserted into the video feed. For example, the insertion detection service 124 at content distributor 102 detects a change to the MPEG encoded redundancy that includes groups of pictures (GOPs) composed of I-frames, B-frames, and/or P-frames. The GOP change is detected as a splice point 150 that indicates where an advertisement has been inserted into the video feed 116.

If a change in the picture group signaling is not detected (i.e., “no” from block 212), then at block 214, a determination is made as to whether a signature is detected of insertion equipment that inserts the local advertisement into the video feed. If a signature of the insertion equipment is detected (i.e., “yes” from block 214), then at block 206, a splice point is detected in the video feed that indicates where a local advertisement has been inserted into the video feed. For example, the insertion detection service 124 at content distributor 102 detects a signature of the advertisement insertion equipment as a vertical and/or horizontal resolution change from the video feed to the video of the inserted advertisement. The resolution change is detected as a splice point 150 that indicates where an advertisement has been inserted into the video feed 116.

If a signature of insertion equipment is not detected (i.e., “no” from block 214), then at block 216, a determination is made as to whether a bit rate change is detected from the video feed to video of the local advertisement that has been inserted into the video feed. If a bit rate change is detected (i.e., “yes” from block 216), then at block 206, a splice point is detected in the video feed that indicates where a local advertisement has been inserted into the video feed. For example, the insertion detection service 124 at content distributor 102 detects where a bit rate for a channel in the video feed 116 goes “flat” which indicates a splice point 150 where an advertisement has been inserted into the video feed 116.

If a bit rate change is not detected (i.e., “no” from block 216), then at block 218, a determination is made as to whether Extended Data Services (XDS) ancillary data discontinuity is detected from the video feed to video of the local advertisement that has been inserted into the video feed. If XDS discontinuity is detected (i.e., “yes” from block 218), then at block 206, a splice point is detected in the video feed that indicates where a local advertisement has been inserted into the video feed. For example, the insertion detection service 124 at content distributor 102 detects a change in the XDS ancillary data that is associated with the video feed 116 which indicates a splice point 150 where an advertisement has been inserted into the video feed 116.

If XDS discontinuity of data is not detected (i.e., “no” from block 218), then at block 220, a determination is made as to whether a change in an audio bit rate is detected from the video feed to video of the local advertisement that has been inserted into the video feed. If a change in an audio bit rate is detected (i.e., “yes” from block 220), then at block 206, a splice point is detected in the video feed that indicates where a local advertisement has been inserted into the video feed. For example, the insertion detection service 124 at content distributor 102 detects a shift in the audio Kbit rate from the video feed 116 to the video for an inserted advertisement which indicates a splice point 150 where an advertisement has been inserted into the video feed 116. If a change in the audio bit rate is not detected (i.e., “no” from block 220), then the method continues at block 202 to receive television media content as a video feed for distribution to the various media devices.

FIG. 3 illustrates various components of an example device 300 that can be implemented as any form of a computer, electronic, appliance, and/or media device to implement various embodiments of local advertisement insertion detection. For example, device 300 can be implemented as a content distributor, a media content server, or an independent insertion detection service as shown in FIG. 1. Device 300 can include one or more media content interfaces 302 via which any type of audio, video, and/or image media content 304 (e.g., television media content) can be received from a media content source and/or distributed to media devices. The media content interfaces 302 can include Internet Protocol (IP) inputs over which streams of media content are received and/or distributed via an IP-based network.

Device 300 further includes one or more communication interfaces 306 that can be implemented as any one or more of a serial and/or parallel interface, a wireless interface, any type of network interface, a modem, and as any other type of communication interface. The communication interfaces 306 provide a connection and/or communication links between device 300 and communication network(s) by which other communication, electronic, and computing devices can communicate data and media content with device 300.

Device 300 can include one or more processors 308 (e.g., any of microprocessors, controllers, and the like) which process various computer-executable instructions to control the operation of device 300 and to implement embodiments of local advertisement insertion detection. Alternatively or in addition, device 300 can be implemented with any one or combination of hardware, firmware, or fixed logic circuitry that is implemented in connection with signal processing and control circuits which are generally identified at 310.

Device 300 can also include computer-readable media 312, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like. Device 300 may also include a recording media 314 to maintain recorded media content 316 that device 300 receives and/or records (e.g., recorded television content, recorded on-demand media content, or assets).

Computer-readable media 312 provides data storage mechanisms to store media content 304, as well as various device applications 318 and any other types of information and/or data related to operational aspects of device 300. For example, an operating system 320, a device manager 322, and an insertion detection service 324 can each be maintained as a computer application and/or software module with the computer-readable media 312 and executed on the processors 308 to implement various embodiments of local advertisement insertion detection.

Although not shown, device 300 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Although embodiments of local advertisement insertion detection have been described in language specific to features and/or methods, it is to be understood that the subject of the appended claims is not necessarily limited to the specific features or methods described. Rather, the specific features and methods are disclosed as example implementations of local advertisement insertion detection.

1. A method, comprising:
receiving a video feed of television media content for distribution to media devices, the video feed including national advertisements and spliced-in local advertisements; and
detecting a splice point in the video feed that indicates where a local advertisement has been inserted into the video feed.

2. A method as recited in claim 1, wherein detecting the splice point in the video feed includes detecting a forced quantization match of video of the local advertisement that has been inserted into the video feed.

3. A method as recited in claim 1, wherein detecting the splice point in the video feed includes detecting a video frame pattern change from the video feed to video of the local advertisement that has been inserted into the video feed.

4. A method as recited in claim 1, wherein detecting the splice point in the video feed includes detecting a timing clock change from the video feed to video of the local advertisement that has been inserted into the video feed.

5. A method as recited in claim 1, wherein detecting the splice point in the video feed includes detecting a change in picture group signaling from the video feed to video of the local advertisement that has been inserted into the video feed.

6. A method as recited in claim 1, wherein detecting the splice point in the video feed includes detecting a signature of insertion equipment that inserts the local advertisement into the video feed.

7. A method as recited in claim 1, wherein detecting the splice point in the video feed includes detecting a bit rate change from the video feed to video of the local advertisement that has been inserted into the video feed.

8. A method as recited in claim 1, wherein detecting the splice point in the video feed includes detecting Extended Data Services (XDS) ancillary data discontinuity from the video feed to video of the local advertisement that has been inserted into the video feed.

9. A method as recited in claim 1, wherein detecting the splice point in the video feed includes detecting a change in an audio bit rate from the video feed to video of the local advertisement that has been inserted into the video feed.

10. A content distributor, comprising:
a media content server configured to receive a video feed of television media content for distribution to media devices, the video feed including national advertisements and spliced-in local advertisements; and
an insertion detection service configured to detect a splice point in the video feed that indicates where a local advertisement has been inserted into the video feed.

11. A content distributor as recited in claim 10, wherein the insertion detection service is further configured to detect the splice point as a forced quantization match of video of the local advertisement that has been inserted into the video feed.

12. A content distributor as recited in claim 10, wherein the insertion detection service is further configured to detect the splice point as a video frame pattern change from the video feed to video of the local advertisement that has been inserted into the video feed.

13. A content distributor as recited in claim 10, wherein the insertion detection service is further configured to detect the splice point as a timing clock change from the video feed to video of the local advertisement that has been inserted into the video feed.

14. A content distributor as recited in claim 10, wherein the insertion detection service is further configured to detect the splice point as a change in picture group signaling from the video feed to video of the local advertisement that has been inserted into the video feed.

15. A content distributor as recited in claim 10, wherein the insertion detection service is further configured to detect the splice point as a signature of insertion equipment that inserts the local advertisement into the video feed.

16. A content distributor as recited in claim 10, wherein the insertion detection service is further configured to detect the splice point as a bit rate change from the video feed to video of the local advertisement that has been inserted into the video feed.

17. A content distributor as recited in claim 10, wherein the insertion detection service is further configured to detect the splice point as Extended Data Services (XDS) ancillary data discontinuity from the video feed to video of the local advertisement that has been inserted into the video feed.

18. A content distributor as recited in claim 10, wherein the insertion detection service is further configured to detect the splice point as a change in an audio bit rate from the video feed to video of the local advertisement that has been inserted into the video feed.

19. One or more computer-readable media comprising computer-executable instructions that, when executed, direct a content distributor to:
receive a video feed of television media content for distribution to media devices, the video feed including national advertisements and spliced-in local advertisements; and
detect a splice point in the video feed that indicates where a local advertisement as been inserted into the video feed.

20. One or more computer-readable media as recited in claim 19, further comprising computer-executable instructions that, when executed, direct the content distributor to detect that a national advertisement has been inserted into the video feed at the splice point after the video feed is received.
